(19) United States
(12) Patent Application Publication
(10) Pub. No.: US 2012/0315443 A1
(43) Pub. Date: Dec. 13, 2012

(54) Floor/Wall Structure

(76) Inventor: David Woolstencroft, Poulton (GB)

(21) Appl. No.: 13/519,669

(22) PCT Filed: Dec. 9, 2010
(86) PCT No.: PCT/GB10/52055

§ 371 Date: Aug. 14, 2012

(30) Foreign Application Priority Data
Dec. 10, 2009 (GB) 0921625.0
Mar. 26, 2010 (GB) 1005105.0

(51) Int. Cl. B32B 3/28; B32B 37/00; B32B 17/04; B32B 15/04; B32B 18/00

(52) U.S. Cl. 428/178; 428/457; 428/446; 428/426; 156/308.2

(57) ABSTRACT

A floor/wall structure, or panel, (10) supported on an I-beam (12) of a steel structure. The floor/wall structure (10) comprises an upper skin layer (14), a lower skin layer (16) and an intermediate layer (18) about 50 mm thick sandwiched between the upper and lower skin layers (4) and (16).

This invention relates to a floor or wall structure.

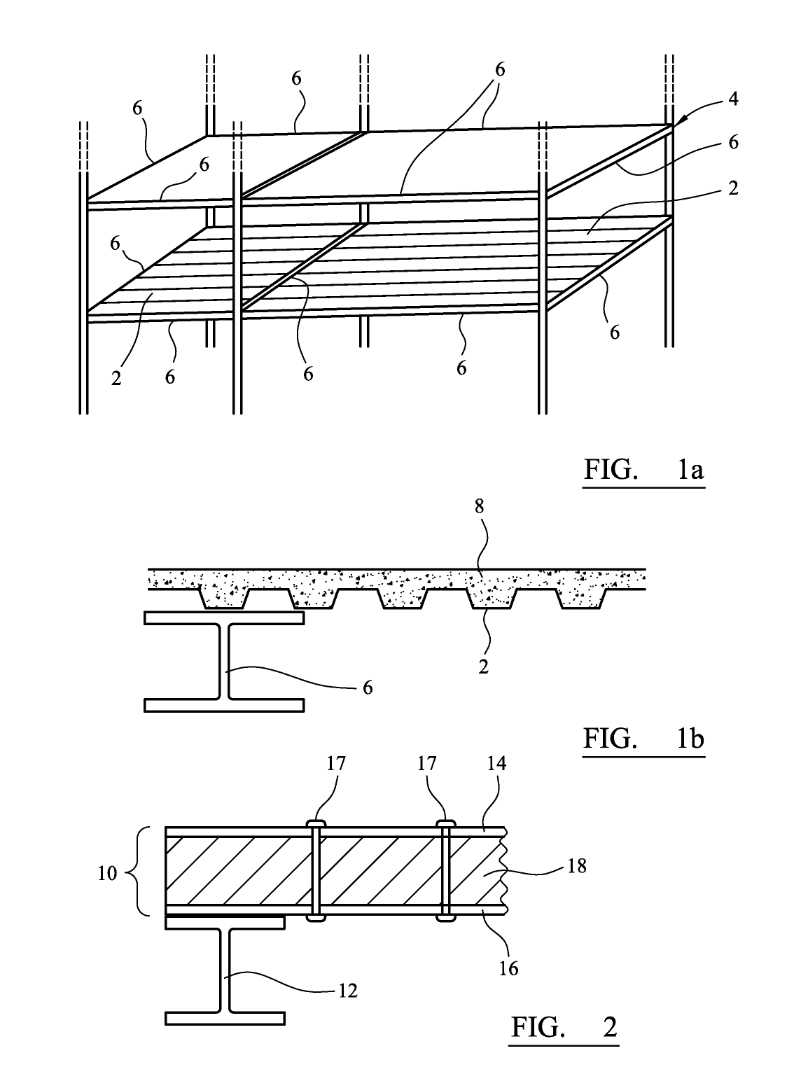

In particular, the invention relates to a floor for a steel structure. Currently, the usual method for building a floor structure for a steel framed building is as shown in FIGS. 1a and 1b. Thin corrugated tin sheets 2 are placed on the steel structure 4 where the floor is required and are fastened around their edges to beams 6 of the steel structure 4. Steel reinforcement bars are then placed on the corrugated surface of the sheets 2 in appropriate locations. After that, concrete 8 (see FIG. 1b) is pumped into place and levelled off. Once dry, the concrete 8 forms the floor in conjunction with the corrugated tin sheets 2. The method is both time consuming and costly. The invention also relates to a structure to be used as a wall panel in a building.

It is an aspect of the present invention to address the above mentioned disadvantages.

According to the present invention there is provided an apparatus and method as set forth in the appended claims. Other features of the invention will be apparent from the dependent claims, and the description which follows.

According to an aspect of the present invention there is provided a floor or wall structure comprising a composite layered structure having outer layers with an intermediate layer therebetween.

The outer layers may be outer skin layers.

The floor/wall structure may be a floor/wall structure for a steel frame building.

At least one of the outer layers may be made of metal, preferably steel.

The outer layers may have a thickness of typically between 1 mm and 10 mm, preferably between 1.5 mm and 7 mm, more preferably between 2 mm and 5 mm.

At least one of the outer layers may be made of a lightweight composite material, which may be a polymeric material, which may be reinforced with fibres, for example glass fibres or ceramic fibres.

At least one of the outer layers may be made of a ballistics resisting material.

At least one of the outer layers may be fabricated from a mouldable material. The material is preferably substantially non-combustible. Preferably the outer layer may have a featured surface, which features may be ribs, which ribs may be parallel ribs extend across substantially all the outer layer. The ribs may be adapted to provide non-slip assistance to people walking on the outer surface. The features may be dimples, may be raised, non-slip patterns, such as dots.

At least one of the outer layers may be made of a ballistics resisting material.

The intermediate layer may be made of a polymeric material, which may be a dough moulding compound. The polymeric material may be reinforced with fibres, such as glass fibres or ceramic fibres. The intermediate layer may be made of metal, in which case spacers, preferably of polymeric material, may be located between the outer and the intermediate layer.

The intermediate layer may form a solid intermediate layer.

The intermediate layer may have a convoluted shape, which may form a convoluted layer. The convolutions may allow the structure of the intermediate layer to have a thickness greater than the thickness of the material of the layer itself, i.e. the intermediate layer may be made of material having a thickness in the range of typically 1 mm to 8 mm, preferably 1.5 mm to 6 mm, more preferably 2 to 4 mm, which material is convoluted to give an intermediate layer having a thickness in the range of 30 mm to 100 mm, preferably 40 mm to 60 mm, more preferably approximately 50 mm.

The convoluted shape of the intermediate layer may be in the form of an egg-crate shape. The egg crate shape may be a hill and valley shape.

The shape of the intermediate layer may be in the form of multiple trapezoidal corrugations, or linear valleys and ridges, the linear valleys may have flat bottoms and the linear ridges may have flat tops. The corrugations may have respective flattened top sections and bottom sections that are adapted to be secured to one or both of the outer layers. The securement may be by means of fixings, such as nuts and bolts, or by bonding, for example with adhesive. The intermediate layer may be produced by an extrusion process.

The outer layers and the intermediate layer may be a single structure, which may be produced in an extrusion process.

The intermediate layer may comprise upper and lower sections having the same shape as described above. The upper and lower sections are preferably secured together, preferably by adhesive, or by fixing means, such as nuts and bolts. The upper and lower sections may be adapted to be abutted against each other, to thereby form a stable structure.

The intermediate layer may incorporate interstitial spaces between the outer layers.

The interstitial spaces, or at least a portion of the spaces, may incorporate an infill material, which may be a blast-proofing material, which may be a shear-thickening material. The infill material may be inserts that extend between the outer layers. The inserts may be tubes that are packed into the interstitial spaces. The inserts may be stiffened tubes that give a crush resistance to the floor/wall structure.

The layers of the floor/wall structure may secured together by adhesive. The layers of the floor/wall structure may secured together by fixings, such as nuts and bolts. The layers of the floor/wall structure may secured together by a curing process of the material of the layers.

The floor structure is preferably adapted to be supported on I-beams of a steel frame structure.

The floor structure may be a floor tile structure adapted to form a raised internal floor surface, preferably in the form of floor tiles. Said floor tiles may measure approximately 200 mm to 700 mm by approximately 200 mm to 700 mm. Said floor tiles may be adapted to be supported on supports, to create a void beneath the floor structure.

According to another aspect of the present invention there is provided a method of producing a floor or wall structure, the method comprising securing an intermediate layer between two outer layers.

The floor or wall structure may be a floor structure for a steel frame building.

At least one of the outer layers may be made of metal, preferably steel, in which case the layers are secured together by fixings, such as nuts and bolts.

The fixings may be located at points of contact between the outer layers and the intermediate layer, which points of contact may be located at hills and wells of convolutions in the intermediate layer.

At least one of the outer layers may be made of a lightweight composite material, which may be a polymeric material, which may be reinforced with fibres, for example glass fibres or ceramic fibres, in which case the layers may be secured together by adhesive, or may be secured together during a curing process of the layers.

The intermediate layer may be made of a polymeric material, which may be a dough moulding compound. The polymeric material may be reinforced with fibres, such as glass fibres or ceramic fibres.

The method may be a method of prefabricating a floor or wall structure. The method may be a method of fabricating a floor or wall structure on site.

The invention extends to an assembly comprising a plurality of floor/wall structures as described above.

The assembly may incorporate at least one steel member to which at least one of the floor/wall structures is secured.

The assembly may be a building or part of a building. The assembly may be a barrier, such as a blast barrier or a ballistics barrier.

For a better understanding of the invention, and to show how embodiments of the same may be carried into effect, reference will now be made, by way of example, to the accompanying diagrammatic drawings in which:

FIG. 1a is a schematic perspective view of a steel frame structure showing a floor section comprising a corrugated tin mesh to be covered with concrete to form a floor of the steel frame structure;

FIG. 1b is a schematic cross-sectional view of the prior art corrugated tin and concrete floor shown in FIG. 1a;

FIG. 2 is a schematic partial cross-sectional view of a first embodiment of floor/wall structure according to the present invention;

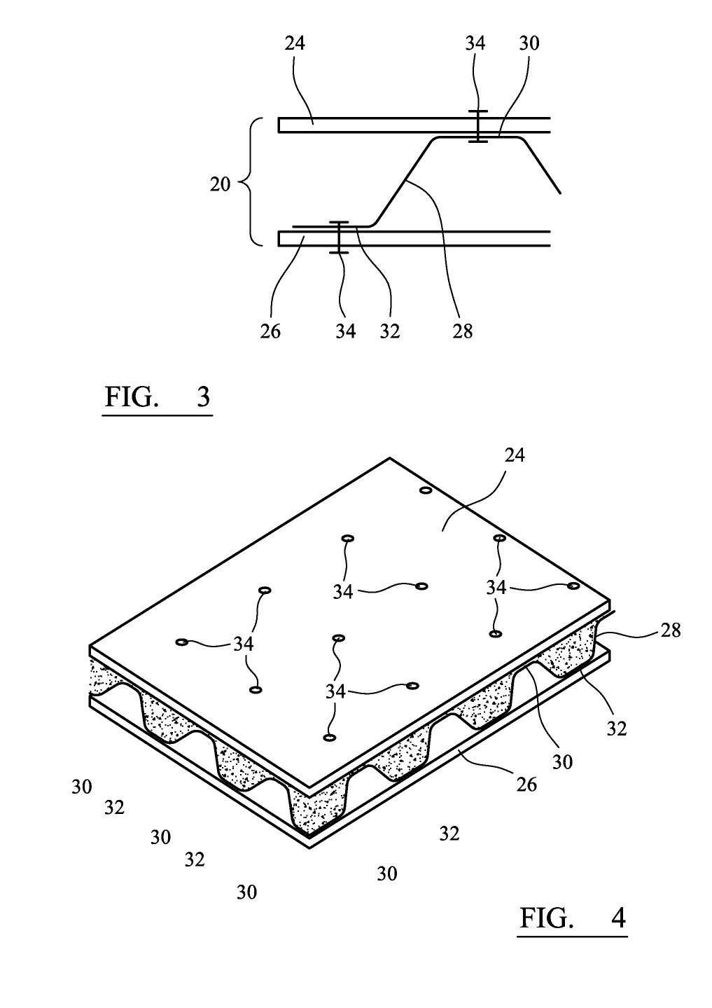

FIG. 3 is a schematic cross-sectional view of a second embodiment of floor/wall structure according to the present invention;

FIG. 3a is a partial schematic perspective view of an intermediate element of the floor/wall structure shown in FIG. 3;

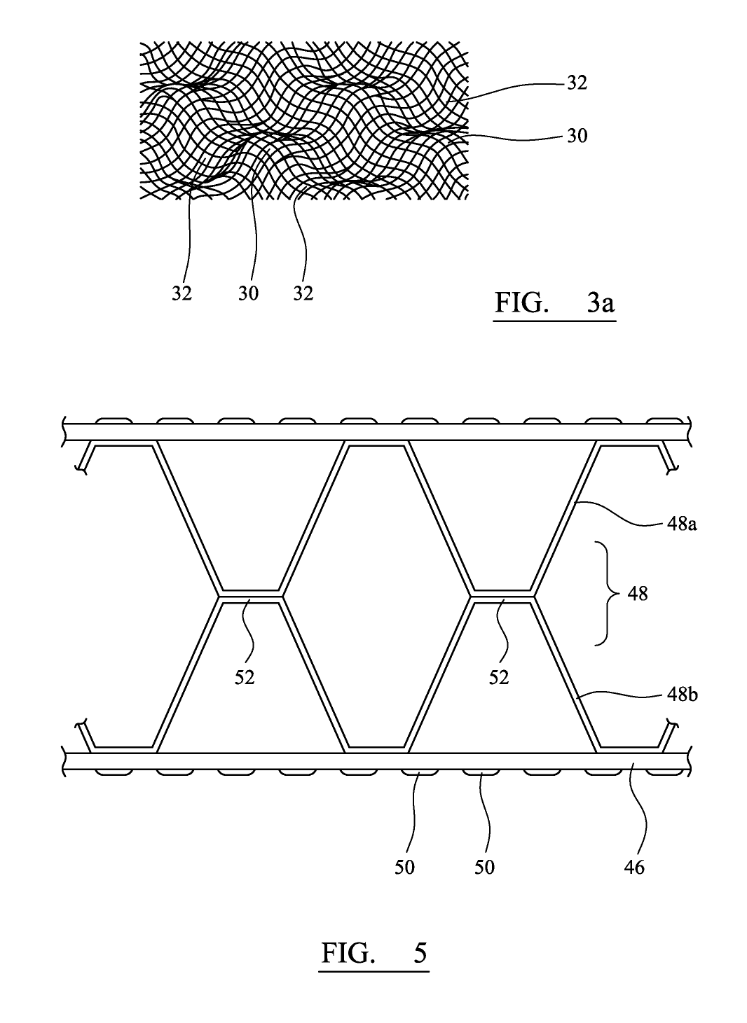

FIG. 4 is a schematic perspective view of a floor/wall structure according to the second embodiment shown in FIG. 3; and

FIG. 5 is a partial schematic sectional view from the side of a third embodiment of floor structure.

FIG. 2 shows a partial cross-sectional view of a floor/wall structure, or panel, 10 supported on an I-beam 12 of a steel structure. The floor/wall structure 10 comprises an upper skin layer 14, a lower skin layer 16 and an intermediate layer 18 about 50 mm thick sandwiched between the upper and lower skin layers 14 and 16.

References to floor structure or floor in the remainder of this description should also be taken to refer to wall structures and walls, unless it is specifically stated that a wall structure/wall is not intended.

The floor structure 10 is for use in building construction in which a section of the floor structure 10 is supported by I-beams of a pre-formed steel structure. The floor structure 10 can be manufactured off site and transported to a building site and lifted in position with a crane or the like.

The floor structure 10 may be provided in suitably sized sections, which could, for example, measure 1 m by 4 m. The size of the elements of the floor structure is chosen to allow the sections of floor structure 10 to be supported on adjacent I-beams 12 of a steel structure, similar to that shown in FIG. 1a. A thicker floor element has more rigidity and so can span a greater distance. Each element of the floor section 10 may be supported across multiple I-beams, if desired. The upper and lower skin layers 14 and 16 may have a thickness of typically 2 mm to 5 mm.

At least one of the skin layers 14 and 16 may be made of steel, or could be made of a lightweight composite, for example a polymer-based material instead of steel, which polymer-based material may be glass reinforced. In the latter case, the at least one skin layer 14/16 can be constructed using glass fibres or ceramic fibres impregnated into a polyester matrix resin comprising the dough moulding compound mentioned above. At least one of the skin layers 14/16 may be made of a material that resists piercing by ballistics to give some ballistic proofing, such para-aramid fibre based fabric or similar material. At least one of the skin layers 14/16 may be made of a transparent or translucent material, such as PMMA. In this way the floor/wall panel may have a decorative function.

The intermediate layer 18 may be made of a dough moulding compound.

The skin layers 14 and 16 may be manufactured as part of an integrated manufacturing process, whereby the skin layers and the intermediate material 18 are co-processed, to improve efficiency of the manufacturing process.

The dough moulding compound that may form the intermediate layer 18 acts as a lightweight structural core when moulded between the two skin layers 14 and 16. The intermediate layer 18 also provides some fire resistance. The material is a polymeric moulding compound which is much lighter than the concrete that is used in prior art structures. The material has extraordinary fire resistance and has been successfully tested to BS476 Part 20. The material also has considerable sheer resistance due to the glass reinforcement, which is a key to efficient sandwich panel types of structure, such as this one. In the version where the skin layers 14 and 16 are made of a composite material, they could be secured to the material forming in the intermediate layer 18 whilst one or both of the intermediate layer 18 and skin layers 14/16 cures, in which situation bonding between the two layers will be achieved.

In the case of steel skin layers 14 and 16 fixings 17 may be used to secure the skin layers 14 and 16 to the intermediate layer 18.

An alternative method of construction of the floor structure 10 referred to above would be to produce the floor structure in situ. This could be achieved by first laying the lower skin layer 16 into position on the I-beams 12, followed by placing the intermediate section 18 on the lower skin 16 potentially with an adhesive layer between the lower skin layer 16 and the intermediate layer 18. After that, the upper skin layer 14 is laid on top of the intermediate layer 18, potentially secured in position with adhesive as mentioned below. Alternatively, the three layers could be secured together by suitable fixings.

FIGS. 3, 3a and 4 show a second embodiment of floor structure 20. The structure 20 consists of an upper skin layer 24 the same as that shown with reference numeral 14 in FIG. 2 and a lower skin layer 26 the same as that shown with reference numeral 16 in FIG. 2. The same materials may be used for the layers 24 and 26 as mentioned above for the upper and lower skin layers 14 and 16 shown in FIG. 2. The main difference for the embodiment shown in FIG. 3 is that the intermediate layer 28 comprises an “egg crate” structure made of the dough moulding compound referred to above. Shown in cross-section in FIG. 3 the egg crate structure 28 has a corrugated appearance, however, in plan, as shown in FIG. 3a the intermediate layer 28 consists of peaks and dips that are not linear in structure but consist of peaks 30 and wells 32, much like an egg crate. The intermediate layer may be made of material that is about 2 mm to 4 mm think, with the egg crate structure have a depth of about 50 mm.

In the embodiments shown in FIGS. 3, 3a and 4, fixings 34 are shown at the peaks 30 and wells 32. The fixings extend through the intermediate layer 28 and through the corresponding upper layer 24 or lower layer 26, whichever is closest. In this way, the three layers of the upper skin layer 24, the intermediate layer 28 and the lower skin layer 26 are secured together to form a composite structure. The structure formed in this way has a great amount of sheer strength, which is the main strength needed for a floor structure of this type, because the load through the floor structure is much less that the shear load.

FIG. 5 shows a third embodiment of floor structure 40. The structure 40 consists of an upper skin layer 44 optionally the same as that shown with reference numeral 14 in FIG. 2 and a lower skin layer 46 optionally the same as that shown with reference numeral 16 in FIG. 2. The same materials may be used for the layers 44 and 46 as mentioned above for the upper and lower skin layers 14 and 16 shown in FIG. 2. The main difference for the embodiment shown in FIG. 5 is that the intermediate layer 48 comprises a corrugated structure made of the dough moulding compound referred to above, or optionally of a lightweight metal. Shown in cross-section in FIG. 5 the intermediate layer 48 has a corrugated appearance. In plan the intermediate layer 48 consists of linear peaks and dips that have flattened maxima and minima. The intermediate layer may be made of material that is about 2 mm to 4 mm thick. As can be seen in FIG. 5 two sections of the corrugated material 48a and 48b are secured together at points 53, optionally with adhesive or fixings. The upper and lower skin layers 44, 46 are secured to the intermediate layer 48 by means of fixings (such as nuts and bolts) or by adhesive.

The intermediate layer 48 may have a depth pf 100 mm, made up by 50 mm for each of the sections 48a and 48b. The non-slip ribs 50 may be 10 mm wide with 10 mm gaps therebetween.

The outer surfaces of the upper and lower skin layers 44, 46 may incorporate a non-slip surface texture, which may be linear flattened ribs or raised dots, or dimples 50.

In this way, the three layers of the upper skin layer 44, the intermediate layer 48 and the lower skin layer 46 are secured together to form a composite structure. The structure formed in this way has a great amount of sheer strength, which is the main strength needed for a floor structure of this type, because the load through the floor structure is much less that the shear load.

The composite floor structure may be made off site with panels thereof being lifted in to position as referred to above. The size of the panel is chosen according to the size of the steel framework on which the composite floor structure sections are secured, in particular the spacing of steel beams of the steel structure.

An alternative method of manufacture for the composite structure 20 would be to secure the three layers 24, 28 and 26 together by means of adhesive at the contact points between the different layers.

A further alternative method of manufacture would be to secure the three layers together with the fixings 34 as shown in FIG. 3, but to prepare the composite structure 20 on site.

A still further alternative would be to extrude the three sections (upper and lower skin layers and intermediate layer as a single piece)

The embodiment shown in FIGS. 3 and 4 has the advantages discussed in relation to FIG. 2, particularly of light weight and ease of construction, as well as off site construction. In addition, heated or cooled air could be blown through the composite structure 20 for heating/cooling purposes.

A variation on the embodiments described above is to make a thinner version that could be used as a floor tile, again possibly in a steel framed structure. Floor tiles are typically provided as solid metal sheets in suitable floor tile sizes of perhaps 30 cm on each side. Such prior art tiles are supported above a floor space on legs or spacers, through which floor space communication cables and service conduits are passed. Both the floor structures shown in FIGS. 2 and 3 could be provided in the form of a floor tile of similar size and thickness to existing floor tiles, but with the composite structure referred to above.

A further embodiment of floor structure uses the upper and lower skins 26, 24 of the first and second embodiments. The same reference numerals are used for corresponding elements. As the intermediate layer 28 the third embodiment uses a shaped metal layer, in an egg-crate shape as with the second embodiment. The three layers are secured together with suitable fixings, as mentioned in relation to the second embodiment. In addition a piece of the dough moulding compound (not shown) is placed between the skins 26, 24 and the intermediate layer 28 at each fixing 34 to provide some thermal insulation. The dough moulding compound may be shaped like a washer to receive the fixing 34 through a central opening. The washers may be located only at the contact between the lower skin 26 and the intermediate layer 28 to provide some thermal insulation and so fire resistance in the event of a fire below. A head (which may be e.g. a bolt head or a nut on a threaded shaft) of each fixing 34 protruding from the lower skin 26 may have a fire proof cap placed thereon. The cap may be made of the dough moulding compound mentioned above.

The intermediate layer 28 creates voids between adjacent hills or valleys that give a lighter weight for the panel 10, whilst still having sufficient structural rigidity to form a floor or wall panel. The voids, or interstitial spaces, may have material incorporated therein to give additional physical properties. For example, a shear-thickening fluid (which may be a gel) could be located in some or all of the voids to provide some blast protection. The shear-thickening fluid exhibits increased viscosity when subjected to strong shear forces, for example in a blast situation. This feature shows particular suitability for use in a wall structure, as part of a blast-strengthened structure.

Shear Thickening Fluid (STF), sometimes referred to as “liquid armour”, normally consists of colloidal nano-particles suspended in an inert, thickening liquid phase such as Ethylene Glycol. When subjected to increasing shear rate or applied stress, concentrated colloidal suspensions can be formed into transient aggregates, or “hydroclusters,” that can dramatically increase the viscosity of the fluid. This process can absorb energy and if in a gel form in the panel would be able to enhance its blast absorption capability.

An alternative filling in the interstitial spaces would be to use tubes that extend between the skins to give increased blast or crush resistance. The tubes may resin injection moulded tubes, that could be made from a fabric material tube that is stiffened by injection of a resin material.

The structures referred to above have significant advantages over the prior art versions. In particular, ease of construction off site, as well as the units being light in weight provide significant advantages.

The term dough moulding compound is used to describe a reinforced plastic mixture of dough-like consistency in an uncured or partially cured state. A typical dough moulding compound consists of polyester resin, glass fibre, calcium carbonate, lubricants and catalysts. The compounds are formed into products by hand lay-up processes and/or compression moulding

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1-14. (canceled)

15. A floor or wall structure comprising:
a composite layered structure having outer layers;
an intermediate layer disposed between the outer layers.

16. The floor or wall structure of claim 15 wherein the floor or wall structure form a floor or wall portion of a steel frame building.

17. The floor or wall structure of claim 15 wherein at least one of the outer layers is made of a lightweight composite material.

18. The floor or wall structure of claim 15 wherein the lightweight composite material is a polymeric material.

19. The floor or wall structure of claim 15 at least one of the outer layers has forms a non-slip surface.

20. The floor or wall structure of claim 15 wherein the intermediate layer is made of a polymeric material.

21. The floor or wall structure of claim 15 wherein the intermediate layer has a convoluted shape and contacts both the outer layers.

22. The floor or wall structure of claim 21 wherein the convoluted shape of the intermediate layer is in the form of a hill and valley shape.

23. The floor or wall structure as claimed in claim 22, wherein the convoluted shape of the intermediate layer is in the form of multiple trapezoidal corrugations.

24. The floor or wall structure of claim 15 wherein the outer layers and the intermediate layer are a single structure.

25. The floor or wall structure of claim 15 wherein the outer layers and the intermediate layer are a single extruded structure.

26. A method of producing a floor or wall structure, the method comprising:
securing an intermediate layer between two outer layers.

27. An assembly, comprising:
a plurality of floor or wall structures;
wherein each of the floor or wall structures comprise:
a composite layered structure having outer layers;
an intermediate layer disposed between the outer layers.

28. The assembly of claim 27 further comprising at least one steel member to which at least one of the floor or wall structures is secured.

29. The assembly of claim 27 wherein the assembly forms at least part of a building.
